(19) United States
(12) Patent Application Publication
(10) Pub. No.: US 2006/0111508 A1
(43) Pub. Date: May 25, 2006

(54) Process for making phenolic resins

(75) Inventor: Theodore Harvey Dailey JR., Kittanning, PA (US)

Correspondence Address: J. Benjamin Bai;Jones Day, Suite 3300, 717 Texas, Houston, TX, 77002, US

(73) Assignee: INDSPEC Chemical Corporation

(21) Appl. No.: 10/994,558

(22) Filed: Nov. 22, 2004

(51) Int. Cl. C08K 5/06; C08K 5/05

(52) U.S. Cl. 524/755; 524/765

(57) ABSTRACT

A process for making a phenolic resin comprises reacting an phenolic compound (e.g., resorcinol) with an olefinically unsaturated compound (e.g., styrene) and an aldehyde (e.g., formaldehyde) in the presence of a compatibilizing agent which is at least partially miscible with water and also preferably at least partially miscible with the phenolic resin produced. Use of the compatibilizing agent substantially reduces foaming in the process and therefore increases the production output.

### PRIOR RELATED APPLICATIONS

Not applicable.

### FEDERALLY SPONSORED RESEARCH STATEMENT

Not applicable.

### REFERENCE TO MICROFICHE APPENDIX

Not applicable.

### FIELD OF THE INVENTION

The invention relates to a process for producing phenolic novolak resins.

### BACKGROUND OF THE INVENTION

In the manufacture of reinforced rubber products, such as automobile tires, it is desirable to have good adhesion between the rubber and the reinforcing material. Originally, adhesion of the rubber to the reinforcing material was promoted by pretreating the reinforcing material with appropriate adhesives. Through development of improved adhesion technology, it is now conventional to incorporate into the rubber during compounding various chemicals that react to improve the adhesion of the reinforcing materials and rubber during the vulcanization process. This compounding adhesion method is now generally practiced even in those processes where the reinforcing materials are pretreated with adhesives.

The conventional method of compounding adhesion comprises compounding into the rubber before vulcanization a two part adhesive system. One part is a methylene donor compound that generates formaldehyde upon heating. The other part of the adhesive system is a methylene acceptor compound. During the vulcanization step the methylene donor upon heating releases formaldehyde and the methylene acceptor reacts with the formaldehyde, rubber and reinforcing material with a resultant increase in adhesion of the rubber to the reinforcing materials. In addition, proper selection of the methylene donor and methylene acceptor can improve many other properties of the final product. The methylene donor and the methylene acceptor are compounded into the rubber and thus have a significant effect on the process of making the reinforced rubber product.

Examples of commonly used methylene donor compounds include hexamethylenetetramine (“HEXA”), hexamethoxymethylmelamine (“HMMM”), and the various methoyl melamines.

Many different methylene acceptor compounds have been tried with various degrees of commercial success. Examples of common methylene acceptor compounds are resorcinol, resorcinol formaldehyde novolak resins, phenol formaldehyde novolak resins and phenol resorcinol formaldehyde novolak resins. In the production of resorcinolic resins in aqueous media, foaming can occur, especially during distillation. Such foaming may become excessive, particularly in the production of aralkyl-resorcinol-formaldehyde resins. Foaming in such production process may limit batch size, thereby increasing production costs. Moreover, it may cause condenser fouling, thereby increasing maintenance costs and production unit downtime.

Therefore, there is a need for a process to produce resorcinolic resins in aqueous media without significant or excessive foaming. Furthermore, there is a need for resorcinolic resins for rubber compounding which yield good processability without sacrificing other desired performance properties.

### SUMMARY OF THE INVENTION

Embodiments of the invention meet the aforementioned needs in one or more of the following aspects. In one aspect, the invention relates to a process for making a phenolic resin, the process comprises sequentially reacting a phenolic compound with an olefinically unsaturated compound and an aldehyde in the presence of a compatabilizing agent which is at least partially miscible with water and preferably partially miscible with the phenolic resin produced therein. The compatibilizing agent is added to the reaction mixture after the addition of the olefinically unsaturated compound but before distillation. Moreover, the compatibilizing agent can be added to the reaction mixture before, simultaneous with, or after the addition of the aldehyde compound.

The compatibilizing agent can be alcohols, glycols, esters, glycol ethers, ketones, or mixtures thereof. In some embodiments, the compatibilizing agent is a solvent which is a water-miscible organic solvent. For example, the compatibilizing agent is methyl ethyl ketone, 2-methoxy-ethanol, 3-methoxy-ethanol, ethanol, or mixtures thereof. In some embodiments, the compatibilizing agent has a boiling point ranging from about 70° C. to about 130° C., from about 80° C. to about 120° C., from about 90° C. to about 110° C., or from about 95° C. to about 105° C.

In some embodiments, the phenolic compound is represented by formula (1) 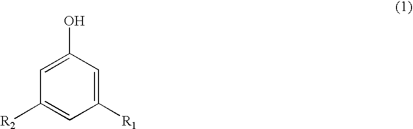
wherein R₁ and R₂ are independently selected from the group consisting of H, OH, NH₂, alkyl of 1-12 carbon atoms, OCOR₃ and OR₃ where R₃ is an alkyl or aryl group of 1-12 carbon atoms. In a preferred embodiment, the phenolic compound is resorcinol.

In some embodiments, the olefinically unsaturated compound is represented by formula (2)
R₄—CH═CH₂ (2)
wherein R₄ is phenyl, substituted phenyl, or other aromatic groups. Examples of suitable olefinically unsaturated compounds include, but are not limited to, styrene, α-methyl styrene, p-methyl styrene, α-chloro styrene, divinyl benzene, vinyl naphthalene, indene, vinyl toluene, and mixtures thereof. In a preferred embodiment, the olefinically unsaturated compound is styrene.

In some embodiments, the aldehyde compound is represented by the formula (3)
R₅—CH═O (3)
wherein R₅ is hydrogen or an alkyl, aryl, or aralkyl. In some embodiments, the R₅ of the aldehyde compound has at least 3 carbon atoms per group. In other embodiments, the aldehyde compound can be formaldehyde, n-butyraldehyde, isobutyraldehyde, valeraldehyde, laurylaldehyde, palmitylaldehyde, stearylaldehyde, or mixtures thereof. In a preferred embodiment, the aldehyde compound is formaldehyde.

In some embodiments, the reaction mixture of the process further includes a second aldehyde. In some embodiments, the second aldehyde is represented by the formula (4)
R₆—CH═O (4)
wherein R₆ is an alkyl, aryl, or aralkyl having at least 4 carbon atoms per group. In some embodiments, the second aldehyde can be n-butyraldehyde, isobutyraldehyde, valeraldehyde, laurylaldehyde, palmitylaldehyde, stearylaldehyde, or mixtures thereof.

In another aspect of the invention, the invention relates to a method for making a vulcanizable rubber composition which comprises making a methylene acceptor from the processes described herein and mixing the methylene acceptor with a rubber component and a methylene donor.

Additional aspects of the invention and characteristics and properties of various embodiments of the invention become apparent with the following description.

### BRIEF DESCRIPTION OF THE DRAWINGS

None.

### DESCRIPTION OF EMBODIMENTS OF THE INVENTION

In the following description, all numbers disclosed herein are approximate values, regardless whether the word “about” or “approximate” is used in connection therewith. They may vary by 1 percent, 2 percent, 5 percent, or, sometimes, 10 to 20 percent. Whenever a numerical range with a lower limit, R^{L} and an upper limit, RU, is disclosed, any number falling within the range is specifically disclosed. In particular, the following numbers within the range are specifically disclosed: R═R^{L}+k*(R^{U}−R^{L}), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed.

Embodiments of the invention provide a process for making a rubber compounding resin comprising reacting sequentially (1) a phenolic compound with (2) an olefinically unsaturated compound and (3) an aldehyde in the presence of (4) a compatibilizing agent which is at least partially miscible with water and preferably also at least partially miscible with the resin produced therein. The compatibilizing agent is added to the reaction mixture after the addition of the olefinically unsaturated compound. It is found that the presence of a compatibilizing agent minimizes or eliminates the formation of foams, thereby increasing batch size and production throughput and also decreasing maintenance costs.

Suitable phenolic compounds are generally represented by the following formula (1): 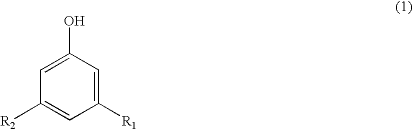
wherein R₁ and R₂ are independently selected from the group consisting of H, OH, NH₂, alkyl of 1-12 carbon atoms, OCOR₃ or OR₃ where R₃ is an alkyl or aryl group of 1-12 carbon atoms. Preferably, R₁ is OH; and R₂ is H or C₁₋₁₀ alkyl, such as methyl, ethyl, propyl, butyl, pentyl, hexyl, etc. For example, suitable phenolic compounds include, but are not limited to, monohydric phenols, polyhydric phenols, mononuclear phenols, polynuclear phenols, or mixtures thereof. Suitable phenolic compounds also include, but are not limited to, phenol, cresol, xylenols having two hydrogen atoms in the ortho- and/or para-positions to the hydroxy group, butylphenol, α-naphthol, β-naphthol, resorcinol, diphenylolmethane, diphenylolpropane, and mixtures thereof. In some embodiments, resorcinol is used as the phenolic compound. In other embodiments, phenol is used as the phenolic compound. Specific examples of suitable phenols include, but are not limited to, unsubstituted phenol; m-cresol; p-cresol; 3,5-xylenol; 3,4-xylenol; 2,3,4-trimethyl phenol; 3-ethyl phenol; 3,5 diethyl phenol; p-butyl phenol; 3,5-dibutyl phenol; p-amyl phenol; p-cyclohexyl phenol; p-octyl phenol; 3,5 dicyclohexyl phenol; p-phynyl phenol; p-crotyl phenol; 3,5-dimethoxy phenol; 3,4,5-trimethoxy phenol; p-ethoxy phenol; p-butoxy phenol; 3-methyl-4-methoxy phenol; p-phenoxy phenol; and mixtures thereof.

Suitable olefinically unsaturated compounds include, but are not limited to, vinyl aromatics generally represented by the following formula (2):
R₄—CH═CH₂ (2)
wherein R₄ is phenyl, substituted phenyl, or other aromatic groups. Examples of suitable olefinically unsaturated compounds include, but are not limited to, styrene, α-methyl styrene, p-methyl styrene, α-chloro styrene, divinyl benzene, vinyl naphthalene, indene, vinyl toluene, and mixtures thereof. In some embodiments, styrene is used as the olefinically unsaturated compound. Typically, the molar ratio of the phenolic compound to the olefinically unsaturated compound is between about 1:0.2 to about 1:1. In some embodiments, the molar ratio is from about 1:0.4 to about 1:0.9, from about 1:0.55 to about 1:0.8, from about 1:0.6 to about 1:0.7. In other embodiments, the molar ratio is between about 1:0.60 to about 1:0.65.

Suitable aldehyde compounds include, but are not limited to aldehydes represented by formula (3):
R₅—CH═O (3)
wherein R₅ is a hydrogen, alkyl, aryl, or aralkyl. In some embodiments, R₅ has at least 3 carbon atoms per group. For example, R₅ can be propyl, isopropyl, butyl, isobutyl, pentyl, isopentyl, hexyl, octyl, nonyl, decyl, benzyl, etc. In some embodiments, the aldehyde is an alkyl aldehyde with at least 4 carbon atoms per molecule, such as n-butyraldehyde or isobutyraldehyde. In other embodiments, the aldehyde is an alkyl aldehyde with at least 5, 6, 7, 8, 9, or 10 carbon atoms per molecule, such as valeraldehyde, laurylaldehyde, palmitylaldehyde or stearylaldehyde. In some other embodiments, the aldehyde is a mixture of two or more aldehydes as described above. In a preferred embodiment, the aldehyde is formaldehyde. The term “formaldehyde” also encompasses paraformaldehyde or any substance which provides formaldehyde, such as formaldehyde formed in situ from the decomposition of oxazolidines or similar compounds. Generally, the molar ratio of phenolic compound to the aldehyde is from about 1:0.1 to about 1:0.6. Sometimes, the molar ratio is from about 1:0.2 to about 1:0.5; 1:0.25 to about 1:0.4; about 1:0.3 to about 1:0.4; or about 1:0.2 to about 1:0.4.

Suitable compatibilizing agents include, but are not limited to, those that are at least partially miscible with water. Preferably, the compatibilizing agent also should be at least partially miscible with the resin produced in the process. A partially miscible solvent is a solvent with is miscible with water or a resin (produced in embodiments of the invention) in at least some proportions at 90° C. In embodiments of the invention, the solvent has a solubility of water or the resin at 90° C. of greater than about 10 wt. %. Preferably, the solubility of water or the resin in the solvent is greater than about 15 wt. %, greater than about 20 wt. %, greater than about 25 wt. %, greater than about 30 wt. %, greater than about 35 wt. %, greater than about 40 wt. %, greater than about 45 wt. %, or greater than about 50 wt. %. In some embodiments, the solubility of water or the resin in the solvent is greater than about 55 wt. %, greater than about 60 wt. %, greater than about 65 wt. %, greater than about 70 wt. %, greater than about 75 wt. %, greater than about 80 wt. %, greater than about 85 wt. %, or greater than about 90 wt. %. In other embodiments, the solubility of water or the resin in the solvent is greater than about greater than about 95 wt. %, greater than about 97 wt. %, or about 100 wt. %. Solubility is defined as the amount of mass of a compound that will dissolve in a unit volume of solution. Aqueous solubility is the maximum concentration of a chemical that will dissolve in pure water at a reference temperature.

The boiling point of a suitable compatibilizing agent should be in the range where at least some of the compatibilizing agent remains in the resin when the mass temperature reaches the boiling point of water. At the same time, the compatibilizing agent boiling point should not be too high since almost all of the compatibilizing agent preferably should be essentially distilled simultaneously with the water, rather than remain in the resin. Therefore, the compatibilizing agent preferably should have a boiling point ranging from about 70° C. to about 130° C., from about 80° C. to about 120° C., from about 90° C. to about 110° C., or from about 95° C. to about 105° C.

Typically, the amount of compatibilizing agent added is preferably less than about 10 wt. %, preferably less than about 5 wt. %, more preferably less than about 2 wt. %. In embodiments of the invention, a compatibilizing agent is added to the reaction mixture after the addition of an olefinically unsaturated compound but before vacuum distillation. In some embodiments, an aldehyde is added after the reaction of a phenolic compound and an olefinically unsaturated compound. A compatibilizing agent can be added to the reaction mixture before, simultaneous with, or after the addition of an aldehyde but before vacuum distillation.

Any water-miscible or partially water-miscible organic solvent which meets the above criteria can be used. Preferably, the water-miscible organic solvents are non-reactive towards any component of the reaction mixture to which they are added. Suitable water-miscible organic solvents include, but are not limited to, lower aliphatic alcohols having from one to about six carbon atoms, lower aliphatic polyhydric alcohols having from two to about six carbon atoms and from two to six hydroxyl groups, and monoalkyl ethers of such lower aliphatic polyhydric alcohols having from two to about six carbon atoms in the alkyl group; polyoxyalkylene glycols and polyoxyalkylene glycol monoethers having at least one oxyether linkage and two alkylene groups, the alkylene groups having from two to four carbon atoms in a straight or branched chain, and having not more than one hydroxyl group etherified with a lower alkyl group having from one to about six carbon atoms; and heterocyclic ethers having up to six ring atoms of which one or two may be ether oxygen, and four or five carbon atoms.

Exemplary lower aliphatic alcohols include, but are not limited to, methanol, ethanol, propanol, isopropanol, butanol, isobutanol, tertiarybutanol, secondary butanol, pentanol, isopentanol, hexanol, isohexanol, and tertiaryhexanol.

Exemplary polyoxyalkylene glycols and glycol ethers include, but are not limited to, the monoethyl ethers of diethylene glycol, diethylene glycol, triethylene glycol, tetraethylene glycol, the monomethyl ether of triethylene glycol, dipropylene glycol, dibutylene glycol, tributylene glycol, tetrabutylene glycol, tetrapropylene glycol, the monomethyl ether of dipropylene glycol, and the monomethyl ether of dibutylene glycol.

Exemplary polyhydric alcohols include, but are not limited to, ethylene glycol, propylene glycol, butylene glycol, the monomethyl ethers of ethylene glycol, propylene glycol and butylene glycol, and the monoethyl ethers of ethylene glycol, propylene glycol and butylene glycol, glycerol, sorbitol, pentaerythritol, and neopentyl glycol.

Mixtures of synthetic alcohols prepared by the Ziegler procedure or the Oxo process can also be used. Most alcohols manufactured by the Oxo process have a branched chain, which makes possible a large number of isomers. The physical properties of these alcohol mixtures are very similar to those of the straight-chain primary alcohols.

In some embodiments, the compatibilizing agent is an alcohol, ether, ketone, or a mixture thereof. In other embodiments, the compatibilizing agent can be methyl ethyl ketone, 2-methoxy-ethanol, 3-methoxy-ethanol, ethanol, or mixtures thereof. In a preferred embodiment, the compatibilizing agent is denatured alcohol.

As mentioned above, an aldehyde is reacted with a phenolic compound and an olefinically unsaturated compound. In some embodiments, a second aldehyde is used in the reaction with the phenolic compound and the olefinically unsaturated compound. Suitable second aldehyde compounds include, but are not limited to aldehydes represented by formula (4):
R₆—CH═O (4)
wherein R₆ is an alkyl, aryl, or aralkyl. In some embodiments, R₆ has at least 3 carbon atoms per group. For example, R₆ can be propyl, isopropyl, butyl, isobutyl, pentyl, isopentyl, hexyl, octyl, nonyl, decyl, benzyl, etc. In some embodiments, the second aldehyde is an alkyl aldehyde with at least 4 carbon atoms per molecule, such as n-butyraldehyde or isobutyraldehyde. In other embodiments, the second aldehyde is an alkyl aldehyde with at least 5, 6, 7, 8, 9, or 10 carbon atoms per molecule, such as valeraldehyde, laurylaldehyde, palmitylaldehyde or stearylaldehyde. In some other embodiments, the second aldehyde is a mixture of two or more aldehydes as described above. The use of two aldehydes in the preparation of a phenolic resin is disclosed in U.S. application Ser. No. 10/368,753, filed on Feb. 18, 2003. The disclosure of this application is incorporated into reference herein in its entirety.

Generally, the molar ratio of phenolic compound to the second aldehyde is from about 1:0.05 to about 1:0.7. Sometimes, the molar ratio is from about 1:0.1 to about 1:0.6, 1:0.25 to about 1:0.5, about 1:0.3 to about 1:0.4; or about 1:0.2 to about 1:0.45. Moreover, the molar ratio of phenolic compound to the total aldehyde is from about 1:0.2 to about 1:2. In some embodiments, the molar ratio is from about 1:0.3 to about 1:1.5, from about 1:0.4 to about 1:1.2; from about 1:0.5 to about 1:1. In other embodiments, the molar ratio is about 1:0.6, about 1:0.7, about 1:0.8 or about 1:0.9. The molar ratio of the second aldehyde to the olefinically unsaturated compound can vary from about 0.25:1 to about 3:1. In some embodiments, the molar ratio is from about 0.35:1 to about 2.5:1; from about 0.5:1 to about 2:1; from about 0.6:1 to about 1.8:1; from about 0.7:1 to about 1.7:1; from about 0.8:1 to about 1.6:1; from about 0.9:1 to about 1.5:1; or from about 1:1 to about 1.2:1.

In a preferred embodiment, the phenolic compound is resorcinol and the resorcinol resins in accordance with embodiments of the invention should have at least 10 mole percent of the phenolic groups aralkylated with the olefinically unsaturated compounds. The resorcinol resins may have from 10 to 100 mole percent of the phenolic groups aralkylated. It is also possible to have two aralkyl groups on some of the phenolic groups. It is preferred that from 25 to 75 mole percent of the phenolic groups be aralkylated and that the phenolic groups are only mono-aralkylated. The exact amount of aralkyl groups is dictated by the desired properties of the final product. For example, high amounts of aralkyl groups may lower the softening point to an unacceptable level. The amount of aralkylation is chosen to give a softening point between about 80° and about 150° C., preferably between about 80° C. and about 120° C. The amount of aralkylation is also chosen to maximize the adhesion of the rubber to reinforcing material, and optimize other properties such as the reactivity of the resorcinol resin with the methylene donor, the reactivity of the resorcinol resin to the double bonds in the rubber, the amount of fuming, the amount of blooming and the characteristics of the vulcanized product, i.e., the stiffness, etc.

The aralkyl group may be reacted onto the resorcinol resin after the resorcinol resin has been prepared. Alternatively the phenolic compound of formula (1) may be first aralkylated and then alone or with additional phenolic compounds reacted with the aldehyde and the second aldehyde. It is also possible to simultaneously aralkylate part or all of the phenolic compound while reacting the same with the aldehydes. It is preferred to first aralkylate the phenolic compound and then react the aralkylated phenolic compound and additional phenolic compound with the first aldehyde and the second aldehyde, if used.

The aralkylation is carried out by reacting the phenolic compound of formula (1) with the desired amount of olefinically unsaturated compound. The reaction of the phenolic group and the olefinically unsaturated hydrocarbon can be carried out in the presence or absence of a solvent. Examples of suitable solvents include benzene, toluene, xylene, ethylbenzene, alkyl alcohols, acetone, and mixtures thereof.

In some embodiments, the reaction of the unsaturated aryl containing hydrocarbon and the phenolic group should be catalyzed. Examples of suitable catalysts are Friedel Crafts catalysts or acid catalysts. The acid catalysts include the inorganic acids such as hydrochloric, sulfuric, phosphoric and phosphorous. The acid catalysts also include the alkyl and aryl sulfonic acids such as benzene sulfonic acid, benzene disulfonic acid, toluene sulfonic acid, xylene sulfonic acid and methane sulfonic acid. The preferred catalysts are the aryl sulfonic acid catalysts. The amount of catalyst is preferably in the range of about 0.01 to about 10 parts of catalyst per 100 parts of phenolic compound. The aralkylation is generally carried out at temperatures between about 50° C. to about 180° C.

In order to prepare rubber compounding resins, a phenolic compound is reacted with an aldehyde. This reaction can take place before or after the phenolic compound is reacted with the olefinically unsaturated compound. It is preferred that the reaction take place after the phenolic compound is reacted with the olefinically unsaturated compound. The condensation reaction of the phenolic compound with the aldehyde may be carried out in the presence or absence of a catalyst. The preferred method is to carry out the reaction in the presence of conventional acid catalysts. Examples of suitable acids including preferred catalysts are set forth above. The reaction may preferably be carried out in the range of about 50° C. to about 200° C.

In an embodiment of the invention, a reactor is first charged with molten resorcinol and an acid catalyst. After about 10 minutes of mixing the resorcinol and catalyst, an olefinically unsaturated compound would then be added streamwise for a period of from about ¾ to about 1¾ hours while the temperature is at about 120° to 140° C. After all the unsaturated compound has been added, the temperature is maintained at about 120° to 140° C. for about ½ hour. In a preferred embodiment, the olefinically unsaturated compound is styrene.

An aldehyde is then added to the reactor streamwise over a period of 2 to 2½ hours. The reaction is exothermic and controlled by the rate of aldehyde addition. The reactor temperature is preferably kept between about 100° C. to about 120° C. and it should not exceed about 135° C. The reaction mixture is then held at reflux for about 15 minutes. In a preferred embodiment, the aldehyde is formaldehyde.

Before, simultaneous with, or after all the aldehyde is added, a compatibilizing agent is added streamwise or in batches and the reaction mixture is held at reflux for about 15 minutes. If desired, the catalyst(s) may be neutralized such that, for each mole of resorcinol used, a sufficient amount of sodium hydroxide or other alkaline compound is charged to the reactor. Atmospheric distillation is conducted until a temperature of about 145° C. is reached.

A vacuum is thereafter applied to the reactor. As a vacuum is applied, the temperature will drop and the resin will generally foam without addition of a compatibilizing agent. A compatibilizing agent, if added to the reaction mixture before distillation, can reduce or eliminate foaming. The compatibilizing agent may further reduce maintenance costs by cleaning the condenser during reflux and by reducing the amount of resin pushed into the condenser by the foaming action. The rate that vacuum is applied is preferably controlled so that the temperature does not drop below about 125° C. and the foam does not enter into the vapor lines. When foaming has subsided, the vacuum should be applied in increments until at least about 715 mm Hg is attained. Pulling vacuum too rapidly may pull resin into the vapor header and condenser, plugging the condenser. When a temperature of about 160° C. has been reached vacuum is released when distillation is complete.

In alternate embodiments, a second aldehyde may be added to the process simultaneously or sequentially with the addition of the first aldehyde.

It should be noted that other methods may exist for making the modified resorcinol resins. For example, the modified resorcinol resins may be made by the methods disclosed in the following U.S. patents and applications with or without modifications: U.S. Pat. Nos. 1,598,546; 2,131,249; 2,173,346; 2,176,951; 3,728,192; 5,021,522; 5,030,692, 5,412,058; 6,265,490; and U.S. patent application Ser. No. 10/368,753, which are incorporated by reference herein in their entirety. Such processes may be modified by incorporation of a compatibilizing agent, as described herein, and are within the scope of this invention.

As mentioned above, a vulcanizable rubber composition can be prepared by using the modified resorcinol resin as the methylene acceptor. The vulcanizable rubber composition comprises: (I) a rubber component selected from natural and synthetic rubbers; and (II) a methylene donor compound which generates formaldehyde by heating; and (III) a methylene acceptor which is based on the resorcinol resin described herein. Optionally, the rubber composition may further comprise (IV) a vulcanizing agent, such as sulfur; and (V) one or more rubber additives.

The rubber component can be any natural rubber, synthetic rubber or combination thereof. Specific examples of synthetic rubbers include neoprene (polychloroprene), polybutadiene, polyisoprene, butyl rubber, copolymers of 1,3-butadiene or isoprene with monomers such as styrene, acrylonitrile and methyl methacrylate as well as ethylene/propylene/diene monomer (EPDM) and in particular ethylene/propylene/dicyclopentadiene terpolymers.

The methylene donor component can be any compound that generates formaldehyde upon heating during the vulcanization and capable of reacting with the methylene acceptor used in the rubber compound formulations. Examples of suitable methylene donors include, but are not limited to, hexamethylenetetramine (HEXA or HMT) and hexamethoxymethylmelamine (HMMM). Other suitable methylene donors are described in U.S. Pat. No. 3,751,331, which is incorporated by reference herein in its entirety. The methylene donor is usually present in concentrations of from about 0.5 to 15 parts per one hundred parts of rubber, preferably from 0.5 to 10 parts per one hundred parts of rubber. The weight ratio of methylene donor to methylene acceptor may vary. But, in general, the weight-ratio will range from 1:10 to 10:1. Preferably, the weight ratio of methylene donor to methylene acceptor ranges from 1:3 to 3:1.

The vulcanizable rubber composition may include a vulcanizing agent, such as sulfur. Examples of suitable sulfur vulcanizing agents include elemental sulfur or sulfur donating vulcanizing agents. Preferably, the sulfur vulcanizing agent is elemental sulfur.

The vulcanizable rubber composition may also include one or more of additives used in rubber compositions. The additives commonly used in the rubber stocks include carbon black, cobalt salts, stearic acid, silica, zinc oxide, fillers, plasticizers, waxes, processing oils retarders, antiozonants and the like.

Accelerators may also be used to control the time and/or temperature required for the vulcanization and to improve the properties of the vulcanizate. Suitable accelerators include, but are not limited to, amines, disulfides, guanidines, thioureas, thiazoles, thiurams, sulfenamides, dithicarbonates and zanthates. Preferably, the primary accelerator is a sulfenamide.

The rubber compositions based on the above resins may be used in the preparation of composite products for the manufacture of tires, power belts, conveyor belts, printing rolls, rubber shoe heels and soles, rubber wringers, automobile floor mats, mud flaps for trucks, ball mill liners, and the like. The rubber compound described herein also may be used as a wire coat or bead coat for use in the tire applications. Any form of the cobalt compounds known in the art to promote the adhesion of rubber to metal, such as stainless steel, may be used. Suitable cobalt compounds which may be employed include cobalt salts of fatty acids such as stearic acid, palmitic, oleic, linoleic and the like; cobalt salts of aliphatic or alicyclic carbocylic acids having 6 to 30 carbon atoms; cobalt chloride, cobalt naphthenate, cobalt neodeconoate, and an organo-cobalt-boron complex commercially available under the trade name Monobond C.

The following examples are presented to exemplify embodiments of the invention. All numerical values are approximate. When numerical ranges are given, it should be understood that embodiments outside the stated ranges may still fall within the scope of the invention. Specific details described in each example should not be construed as necessary features of the invention.

### EXAMPLE 1

### Synthesis of Rubber Compounding Resin with No Solvent Added

132.8 grams of resorcinol was charged to a reactor and heated to 1200-130° C. 0.4 grams of p-toluene sulfonic acid was then similarly charged and mixed for 10 minutes at 120° to 130° C. Styrene (88.4 grams) was then charged to the reactor streamwise. The resulting reaction was exothermic and was controlled by the rate of styrene addition. The addition time was about 1 hour. Temperature was maintained at 125° to 135° C. for the reaction and then held at 135°-145° C. for ½ hour after all of the styrene had been added. A 36.5% formaldehyde solution in the amount of 65.5 grams was then charged to the reactor streamwise. The resulting reaction was exothermic and was controlled by the rate of formaldehyde addition. The reactor temperature was not allowed to exceed 135° C. Addition time for formaldehyde was about 2 hours. After all the formaldehyde was added, the mixture was held at reflux for 15 minutes. An 80 wt. % water solution of low molecular weight resorcinol homopolymer (typically comprising about 2 to 3 repeating units) was then charged to the reactor streamwise in an amount of 26.3 grams. Addition time was about ½ hour. After all the formaldehyde had been added, the mixture was held at reflux for ¼ hour. About 0.2 gram of a 50% sodium hydroxide solution was then added and reactor valves were set for atmospheric distillation. Atmospheric distillation was continued until a temperature of 145° C. was reached. The kettle was then switched to vacuum distillation. The rate that the vacuum was applied was controlled so that the temperature did not drop below 125° C. and the resin did not foam into the vapor lines. The amount of foam that was produced was observed. When a temperature of 160° C. was reached, the vacuum was released and the kettle emptied. The resulting resin had a softening point of about 106.9° C. and a moisture content of 0.7%. Free resorcinol was about 1.2% and styrene was <0.05%.

### EXAMPLES 2-5

### Synthesis of Rubber Compounding Resin with Various Solvents Added

The procedure of Comparative Example 1 was repeated except 4.7 grams of various solvents were added to the mixture before distillation. The results of these e shown in Table 1 as well as that of Comparative Example 1. The values are in %.

TABLE 1

| | | Boiling | | | | Softening | Free | | |
|---|---|---|---|---|---|---|---|---|---|
| | Solvent | Point | | Water | Solvent | Point | Resorcinol | Styrene | Foaming |
| Sample | Used | ° C. | | % | % | ° C. | % | % | Observed |
| 1 | None | NA | | 0.12 | | 106.9 | 1.2 | <0.05 | Moderate |
| 2 | 2-Methoxy | 124° | C. | 0.16 | 0.57 | 107.2 | 0.85 | <0.05 | Little |
| | Ethanol ⁱ | | | | | | | | |
| 3 | Methyl Ethyl | 80° | C. | 0.11 | <0.05 | 106.4 | 1.2 | <0.05 | Little |
| | Ketone ⁱⁱ | | | | | | | | |
| 4 | Denatured | 79° | C. | 0.11 | <0.05 | 107.5 | 1.3 | <0.05 | Little |
| | Alcohol ⁱⁱⁱ | | | | | | | | |
| 5 | Dimethyl | 82-83° | C. | 0.4 | 0.18 | 107.2 | 0.98 | 0.011 | None |
| | Cellosolve ^{iv} | | | | | | | | |

ⁱ 2-Methoxy Ethanol (i.e., methyl cellosolve) was supplied by Fisher Scientific.
ⁱⁱ Methyl Ethyl Ketone was supplied by Fisher Scientific.
ⁱⁱⁱ Denatured alcohol was Tecsol A ethyl alcohol supplied by Eastman Chemical.
^{iv} Dimethyl Cellosolve (i.e., 1,2 dimethoxyethane) was supplied by Sigma Aldrich.

In Table 1, “Boiling Point” refers to the boiling point of the solvent; “Water %” the water content in the final resin; “Solvent %” the solvent content of the final resin; “Softening Point” the softening point of the final resin; and “Free Resorcinol %” the content of free resorcinol in the final resin.

Experience has shown that the extent of foaming observed in lab scale experiments gets magnified in semi-production and production scale processes. Even “moderate” foaming in lab reactors often results in serious foaming in production reactors, thus reducing batch size or causing fouling of reactor condensers. It has been found that addition of an appropriate solvent which reduces or eliminates foaming can permits batch size increases from 65% of normal size to about 80-85% of normal run size for resins which do not typically foam. As shown in Table 1, all the solvents tested reduced or eliminated foaming and gave similar results in the final resins. The ethers showed trace amounts of solvents retained in the resin but not enough to be problematic in use.

As demonstrated above, embodiments of the invention provide a process for making a rubber compounding resin. The process eliminates or reduces foaming in production processes. As a result, the batch sizes are increased and the production costs are decreased. Moreover, the improved processability does not compromise the desirable performance properties of the resins.

While the invention has been described with respect to a limited number of embodiments, the specific features of one embodiment should not be attributed to other embodiments of the invention. No single embodiment is representative of all aspects of the inventions. In some embodiments, the compositions may include numerous compounds not mentioned herein. In other embodiments, the compositions do not include, or are substantially free of, any compounds not enumerated herein. Variations and modifications from the described embodiments exist. The method of making the resins is described as comprising a number of acts or steps. These steps or acts may be practiced in any sequence or order unless otherwise indicated. Finally, any number disclosed herein should be construed to mean approximate, regardless of whether the word “about” or “approximately” is used in describing the number. The appended claims intend to cover all those modifications and variations as falling within the scope of the invention.

What is claimed is:

1. A process for making a phenolic resin comprising reacting (a) a phenolic compound having the formula (1) 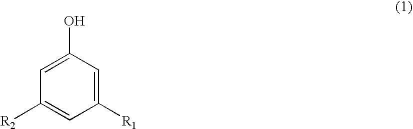
wherein R₁ and R₂ are independently selected from the group consisting of H, OH, NH₂, alkyl of 1-12 carbon atoms, OCOR₃ and OR₃ where R₃ is an alkyl or aryl group of 1-12 carbon atoms, with (b) an olefinically unsaturated compound having the formula (2)
R₄—CH═CH₂ (2)
wherein R₄ is selected from the group consisting of phenyl, substituted phenyl, and other aromatic groups, and (c) an aldehyde compound having the formula (3)
R₅—CH═O (3)
wherein R₅ is hydrogen, an alkyl, aryl, or aralkyl, in the presence of a compatibilizing agent which is at least partially miscible with water, wherein the compatibilizing agent is added to the reaction mixture after the addition of the olefinically unsaturated compound to the phenolic compound.

2. The process of claim 1, wherein the compatibilizing agent is at least partially miscible with the phenolic resin.

3. The process of claim 1, wherein the compatibilizing agent is a water-miscible organic solvent.

4. The process of claim 2, wherein the water-miscible organic solvent is selected from alcohols, glycols, esters, glycol ethers, ketones, or mixtures thereof.

5. The process of claim 4, wherein the water-miscible organic solvent is selected from methyl ethyl ketone, 2-methoxy-ethanol, 3-methoxy-ethanol, ethanol, or a mixture thereof.

6. The process of claim 1, wherein the compatibilizing agent is ethyl alcohol.

7. The process of claim 4, wherein the water-miscible organic solvent has a boiling point ranging from about 70° C. to about 130° C.

8. The process of claim 4, wherein the water-miscible organic solvent has a boiling point ranging from about 80° C. to about 120° C.

9. The process of claim 4, wherein the water-miscible organic solvent has a boiling point ranging from about 90° C. to about 110° C.

10. The process of claim 4, wherein the water-miscible organic solvent has a boiling point ranging from about 95° C. to about 105° C.

11. The process of claim 1, wherein the compatibilizing agent is added to the reaction mixture before distillation.

12. The process of claim 1, wherein the compatibilizing agent is added to the reaction mixture before, simultaneous with, or after the addition of the aldehyde compound.

13. The process of claim 1, wherein the compound of formula (1) is selected from the group consisting of monohydric phenols, polyhydric phenols, mononuclear phenols, polynuclear phenols and mixtures thereof.

14. The process of claim 13, wherein the phenolic compound of formula (1) is selected from phenol, cresol, xylenols having two hydrogen atoms in the ortho- and/or para-positions to the hydroxy group, butylphenol, α-naphthol, β-naphthol, resorcinol, diphenylolmethane, diphenylolpropane, or a mixture thereof.

15. The process of claim 14, wherein the phenolic compound of formula (1) is selected from unsubstituted phenol, m-cresol, p-cresol, 3,5-xylenol, 3,4-xylenol, 2,3,4-trimethyl phenol, 3-ethyl phenol, 3,5 diethyl phenol, p-butyl phenol, 3,5-dibutyl phenol, p-amyl phenol, p-cyclohexyl phenol, p-octyl phenol, 3,5 dicyclohexyl phenol, p-phynyl phenol, p-crotyl phenol, 3,5-dimethoxy phenol, 3,4,5-trimethoxy phenol, p-ethoxy phenol, p-butoxy phenol, 3-methyl-4-methoxy phenol, p-phenoxy phenol, or a mixture thereof.

16. The process of claim 15, wherein the phenolic compound of formula (1) is resorcinol.

17. The process of claim 1, wherein the olefinically unsaturated compound of formula (2) is selected from styrene, α-methyl styrene, p-methyl styrene, α-chloro styrene, divinyl benzene, vinyl naphthalene, indene, vinyl toluene, or a mixture thereof.

18. The process of claim 17, wherein the olefinically unsaturated compound of formula (2) is styrene.

19. The process of claim 1, wherein the aldehyde compound of formula (3) is selected from formaldehyde, propionaldehyde, n-butyraldehyde, isobutyraldehyde, valeraldehyde, laurylaldehyde, palmitylaldehyde, stearylaldehyde, or a mixture thereof.

20. The process of claim 19, wherein the aldehyde compound of formula (3) is formaldehyde.

21. The process of claim 19, wherein the aldehyde compound of formula (3) is formaldehyde produced from an oxazolidine compound.

22. The process of claim 1, wherein the R₅ of the aldehyde compound has at least 3 carbon atoms per group.

23. The process of claim 1, further comprising reacting a second aldehyde compound having the formula (4)
R₆-CH═O (4)
wherein R₆ is an alkyl, aryl, or aralkyl.

24. The process of claim 23, wherein the R₆ of the aldehyde compound has at least 4 carbon atoms per group.

25. The process of claim 23, wherein the compound of formula (4) is selected from n-butyraldehyde, isobutyraldehyde, valeraldehyde, laurylaldehyde, palmitylaldehyde, stearylaldehyde, or a mixture thereof.

26. The process of claim 1, wherein the molar ratio of compound (1) to compound (2) is from about 1:0.2 to about 1:1.

27. The process of claim 1, wherein the molar ratio of compound (1) to compound (2) is from about 1:0.4 to about 1:0.9.

28. The process of claim 1, wherein the molar ratio of compound (1) to compound (2) is from about 1:0.5 to about 1:0.8.

29. The process of claim 1, wherein the molar ratio of compound (1) to compound (3) is from about 1:0.1 to about 1:0.6.

30. The process of claim 1, wherein the molar ratio of compound (1) to compound (3) is from about 1:0.2 to about 1:0.5.

31. The process of claim 1, wherein the molar ratio of compound (1) to compound (3) is from about 1:0.25 to about 1:0.4.

32. The process of claim 23, wherein the molar ratio of compound (1) to compound (4) is from about 1:0.05 to about 1:0.7.

33. The process of claim 23, wherein the molar ratio of compound (1) to compound (4) is from about 1:0.1 to about 1:0.6.

34. The process of claim 23, wherein the molar ratio of compound (1) to compound (4) is from about 1:0.3 to about 1:0.5.

35. The process of claim 1, wherein the reaction occurs in the presence of an acid catalyst.

36. The process of claim 35, wherein the acid catalyst is selected from benzene sulfonic acid, benzene disulfonic acid, p-toluene sulfonic acid; xylene sulfonic acid, methane sulfonic acid, or a mixture thereof.

37. A method of making a vulcanizable rubber composition comprising
a. making a methylene acceptor according to claim 1; and
b. mixing the methylene acceptor with a rubber component and a methylene donor.
